(19) United States
(12) Patent Application Publication
(10) Pub. No.: US 2024/0069559 A1
(43) Pub. Date: Feb. 29, 2024

(54) AUTONOMOUS MOVING ROBOT

(71) Applicant: THK CO., LTD., Tokyo (JP)

(72) Inventors: Hitoshi Kitano, Tokyo (JP); Tsubasa Usui, Tokyo (JP)

(73) Assignee: THK CO., LTD., Tokyo (JP)

(21) Appl. No.: 18/268,828

(22) PCT Filed: Dec. 21, 2021
(86) PCT No.: PCT/JP2021/047260

§ 371 Date: Jun. 21, 2023

(30) Foreign Application Priority Data
Dec. 25, 2020 (JP) 2020-216979

(51) Int. Cl. G05D 1/02

(52) U.S. Cl. CPC G05D 1/0236; G05D 1/0246

(57) ABSTRACT

This autonomous moving robot is an autonomous moving robot for reading a sign disposed along a movement path using an imaging unit mounted therein and being guided and moving in accordance with the sign. The autonomous moving robot includes a calculation unit having a limited-range search mode. In the limited-range search mode, a first scanning range is set in a part of a captured image captured by the imaging unit on the basis of a registration position of the sign and the sign is searched for in the first scanning range.

### TECHNICAL FIELD

The present invention relates to an autonomous moving robot.

Priority is claimed on Japanese Patent Application No. 2020-216979, filed Dec. 25, 2020, the content of which is incorporated herein by reference.

### BACKGROUND ART

In the following Patent Document 1, an automated vehicle allocation system is disclosed. The automated vehicle allocation system includes: a plurality of signs, which are disposed on a path along which a vehicle can run, configured that running operation instruction information for issuing a running operation instruction is provided, and configured to display the running operation instruction information; and an autonomous vehicle, which is configured to extract the running operation instruction information of an oncoming sign from the plurality of signs, control running of the vehicle on the basis of the running operation instruction information of the extracted sign, and enable the vehicle to run along the path.

The autonomous vehicle includes: a distance measurement means for measuring a distance to a sign located forward in a traveling direction; and an imaging means for acquiring an image of a sign having substantially a certain size in accordance with the distance supplied from the distance measurement means, wherein the autonomous vehicle extracts the running operation instruction information of the sign from the image acquired by the imaging means. Specifically, the autonomous vehicle performs a light and shade template matching process using an outer frame of the sign as a template with respect to the image acquired by the imaging means, and calculates a center position of the sign to perform the sign extraction process.

### CITATION LIST

### Patent Document

### [Patent Document 1]

Japanese Unexamined Patent Application, First Publication No. H11-184521

### SUMMARY OF INVENTION

### Technical Problem

Conventionally, when the above-described autonomous moving robot detects a sign with a camera mounted therein or the like, image processing for searching for a sign from the entire captured image captured by the camera is performed. However, when an angle of view of the camera is wide, there is a problem that disturbances similar to signs increase in the captured image and the accuracy of sign detection decreases. Also, there is a problem that a period of image processing time increases when an amount of information in the captured image increases.

An objective of the present invention is to provide an autonomous moving robot capable of improving the accuracy of sign detection and reducing a period of image processing time required for sign detection.

### Solution to Problem

In order to solve the above-described problems, according to an aspect of the present invention, an autonomous moving robot for reading a sign disposed along a movement path using an imaging unit mounted therein and being guided and moving in accordance with the sign. The autonomous moving robot includes a calculation unit having a limited-range search mode, the limited-range search mode in which a first scanning range is set in a part of a captured image captured by the imaging unit on the basis of a registration position of the sign and the sign is searched for in the first scanning range.

### Advantageous Effects of Invention

According to an aspect of the present invention, it is possible to improve the accuracy of sign detection and reduce a period of image processing time in an autonomous moving robot.

### BRIEF DESCRIPTION OF DRAWINGS

FIG. 1 is a schematic diagram showing a movement state of an autonomous moving robot according to a first embodiment of the present invention viewed from above.

FIG. 2 is a block diagram showing a configuration of the autonomous moving robot according to the first embodiment of the present invention.

FIG. 3 is a front view showing an example of a detection target of a signpost read by a signpost detection unit according to the first embodiment of the present invention.

FIG. 4 is an explanatory diagram for describing a limited-range search mode according to the first embodiment of the present invention.

FIG. 5 is a flowchart showing path creation and operation of the autonomous moving robot including a user input according to the first embodiment of the present invention.

FIG. 6 is a flowchart showing internal image processing of the autonomous moving robot according to the first embodiment of the present invention.

FIG. 7 is a flowchart showing path creation and operation of an autonomous moving robot including a user input according to a second embodiment of the present invention.

FIG. 8 is a flowchart showing internal image processing of the autonomous moving robot according to the second embodiment of the present invention.

FIG. 9 is a flowchart showing internal image processing of the autonomous moving robot according to the second embodiment of the present invention.

FIG. 10 is a flowchart showing internal image processing of an autonomous moving robot according to a third embodiment of the present invention.

FIG. 11 is a flowchart showing internal image processing of the autonomous moving robot according to the third embodiment of the present invention.

FIG. 12 is a schematic diagram showing a movement state of the autonomous moving robot according to the third embodiment of the present invention viewed from above.

FIG. 13 is a schematic diagram showing a movement state of the autonomous moving robot according to the third embodiment of the present invention viewed from above.

FIG. 14 is a schematic diagram showing a movement state of the autonomous moving robot according to the third embodiment of the present invention viewed from above.

FIG. 15 is a schematic diagram showing a movement state of the autonomous moving robot according to the third embodiment of the present invention viewed from above.

FIG. 16 is a schematic diagram showing a movement state of the autonomous moving robot according to the third embodiment of the present invention viewed from above.

### DESCRIPTION OF EMBODIMENTS

Hereinafter, embodiments of the present invention will be described with reference to the drawings.

### First Embodiment

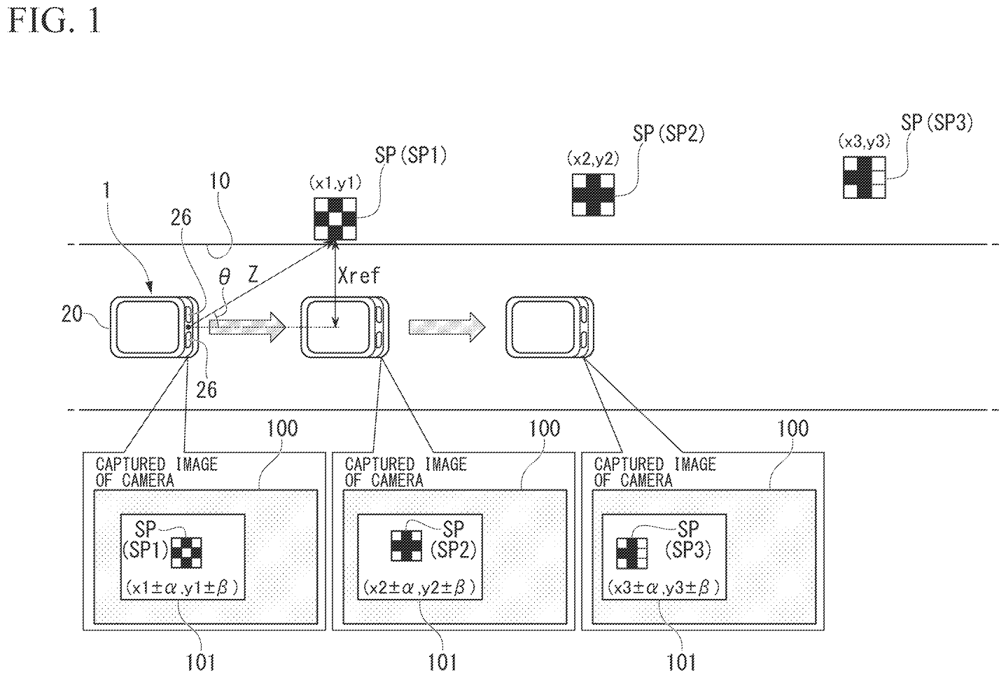

FIG. 1 is a schematic diagram showing a movement state of an autonomous moving robot 1 according to a first embodiment of the present invention viewed from above.

As shown in FIG. 1, the autonomous moving robot 1 moves while sequentially reading a plurality of signposts SP disposed along a movement path 10 using an imaging unit 26 mounted on a robot main body 20. That is, the autonomous moving robot 1 moves along the movement path 10 in accordance with guidance of the plurality of signposts SP.

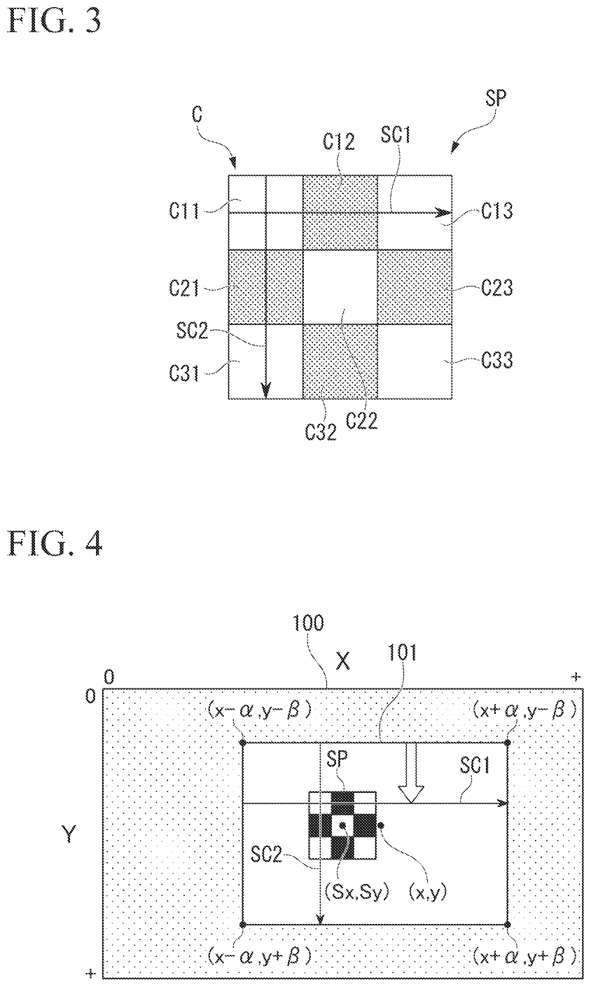

Here, “signpost” refers to a structure having a sign and placed at a prescribed place in the movement path 10 or in the vicinity of the movement path 10. The sign includes identification information (a target ID) of the structure. As shown in FIG. 3 to be described below, the sign of the present embodiment is a detection target C in which a first cell (C11, C13, or the like) capable of reflecting light and a second cell (C12, C21, or the like) incapable of reflecting light are disposed on a two-dimensional plane. Also, the sign may be a one-dimensional code (barcode), another two-dimensional code, or the like.

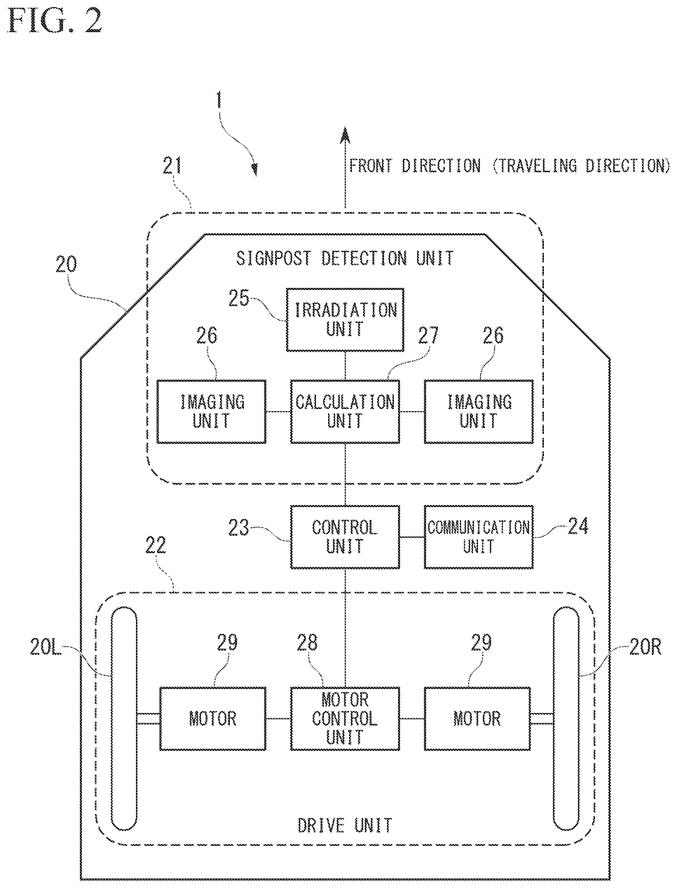

FIG. 2 is a block diagram showing a configuration of the autonomous moving robot 1 according to the first embodiment of the present invention.

As shown in FIG. 2, the autonomous moving robot 1 includes a signpost detection unit 21, a drive unit 22, a control unit 23, and a communication unit 24.

The signpost detection unit 21 includes an irradiation unit 25, two imaging units 26, and a calculation unit 27. Also, the drive unit 22 includes a motor control unit 28, two motors 29, and left and right drive wheels 20L and 20R. Also, the configurations of the signpost detection unit 21 and the drive unit 22 are just one example and they may have other configurations.

The irradiation unit 25 is attached to a central position on the front surface of the autonomous moving robot 1 in a traveling direction and radiates infrared LED light in a forward direction as an example. The infrared LED light is suitable for a dark place such as a factory, a place with strong visible light, or the like. Also, the irradiation unit 25 may have a configuration in which detection light other than infrared LED light is radiated.

The two imaging units 26 are disposed on the left and right of the signpost detection unit 21. For example, a camera combined with an infrared filter is used for the two imaging units 26 to image reflected light (infrared LED light) reflected by the signpost SP.

The calculation unit 27 calculates a distance (distance Z) and a direction (angle θ) at which the signpost SP is located with respect to the autonomous moving robot 1, by forming binarized image data composed of black and white by performing a binarization process on the basis of captured images transmitted from the two imaging units 26, and further by performing an arithmetic operation based on triangulation (triangulation using a difference between the captured images of the two imaging units 26) using binarized image data.

Also, when a plurality of signposts SP are included in the captured image, the calculation unit 27 detects identification information (a target ID) of the signpost SP to select a target signpost SP and calculates the distance Z and the angle θ to the target signpost SP.

The drive wheel 20L is provided on the left side in the traveling direction of the autonomous moving robot 1. The drive wheel 20R is provided on the right side in the traveling direction of the autonomous moving robot 1. Also, the autonomous moving robot 1 may have wheels other than the drive wheels 20L and 20R to stabilize the posture of the autonomous moving robot 1.

The motor 29 rotates the left and right drive wheels 20L and 20R in accordance with the control of the motor control unit 28.

The motor control unit 28 supplies electric power to the left and right motors 29 on the basis of an angular velocity command value input from the control unit 23. The left and right motors 29 rotate at an angular velocity corresponding to the electric power supplied from the motor control unit 28. Thereby, the autonomous moving robot 1 moves forward or backward. Also, the traveling direction of the autonomous moving robot 1 is changed by forming a difference between the angular velocities of the left and right motors 29.

The control unit 23 controls the drive unit 22 on the basis of information read from the signpost SP by the signpost detection unit 21.

In an example of movement shown in FIG. 1, the autonomous moving robot 1 moves while maintaining a certain distance from the left side of the movement path 10. The autonomous moving robot 1 determines a distance Xref for the signpost SP, acquires a distance Z and an angle θ to the detected signpost SP to maintain a certain distance from the left side of the movement path 10, and calculates a traveling direction in which the distance Z and the angle θ satisfy a predetermined condition.

The angle θ is an angle formed by the traveling direction of the autonomous moving robot 1 and the direction of the detected signpost SP. The autonomous moving robot 1 travels so that a distance between the signpost SP and the target path is Xref. When the distance Z to the signpost SP (for example, a signpost SP1) that guides the autonomous moving robot 1 becomes less than a predetermined threshold value, the autonomous moving robot 1 switches the target to the next signpost SP (for example, a signpost SP2) and moves.

FIG. 3 is a front view showing an example of the detection target C of the signpost SP read by the signpost detection unit 21 according to the first embodiment of the present invention.

As shown in FIG. 3, the signpost SP includes a detection target C in which a first cell (C11, C13, or the like) capable of reflecting infrared LED light and a second cell (C12, C21, or the like) incapable of reflecting infrared LED light are disposed on a two-dimensional plane.

The detection target C of the present embodiment includes a matrix pattern of three rows×three columns. Specifically, the detection target C includes the first cell C11 of a first row and a first column, the second cell C12 of the first row and a second column, the first cell C13 of the first row and a third column, the second cell C21 of a second row and the first column, the first cell C22 of the second row and the second column, the second cell C23 of the second row and the third column, the first cell C31 of the third row and the first column, the second cell C32 of a third row and the second column, the first cell C33 of the third row and the third column.

The first cells C11, C13, C22, C31, and C33 are formed of a material having a high reflectivity of infrared LED light such as, for example, an aluminum foil or a thin film of titanium oxide. The second cells C12, C21, C23, and C32 are formed of a material having a low reflectivity of infrared LED light such as, for example, an infrared cut film, a polarizing film, an infrared absorber, or black felt.

The calculation unit 27 detects the signpost SP by performing first scanning SC1 and second scanning SC2 on the detection target C. In the first scanning SC1, for example, the first cell C11, the second cell C12, and the first cell C13 disposed in “white, black, white” of the first row are detected. In the second scanning SC2, for example, the first cell C11, the second cell C21, and the first cell C31 disposed in “white, black, white” of the first column are detected.

In the expression of a binary code in which white is “1” and black is “0 (zero),” “white, black, white” can be indicated as “1, 0, 1” and the calculation unit 27 detects the signpost SP when “1, 0, 1” by the first scanning SC1 and “1, 0, 1” by the second scanning SC2 are successfully read.

The calculation unit 27 reads the identification information (target ID) of the signpost SP from the remaining cells of the detection target C (the first cell C22 of the second row and the second column, the second cell C23 of the second row and the third column, the second cell C32 of the third row and the second column, and the first cell C33 of the third row and third column). In the example shown in FIG. 3, the calculation unit 27 can be allowed to read the identification information of the signpost SP with 4-bit information.

Returning to FIG. 2, the communication unit 24 communicates with a higher-order system (not shown). The higher-order system has registration position information of the signpost SP for setting a scanning range 101 for searching for the signpost SP from a captured image 100 (see FIG. 1) captured by the imaging unit 26. As shown in FIG. 1, the registration position (x1 to x3, y1 to y3) of the signpost SP is set for each of the signposts SP1 to SP3.

The higher-order system can have, for example, path creation software that can register a registration position (x, y) of the signpost SP on the captured image 100 for each signpost SP by the user input. Also, the configuration in which the registration position (x, y) of the signpost SP on the captured image can be registered directly for each signpost SP with respect to the autonomous moving robot 1 may be adopted. In the present embodiment, the higher-order system provides the registration position information of the signpost SP to the autonomous moving robot 1.

The control unit 23 receives the registration position information of the signpost SP from the higher-order system via the communication unit 24. Also, the calculation unit 27 sets a scanning range 101 (a first scanning range) in a part of the captured image 100 captured by the imaging unit 26 on the basis of registration position information of the signpost SP obtained through the control unit 23 and searches for the signpost SP in the scanning range 101. Hereinafter, the limited-range search mode of the calculation unit 27 will be described with reference to FIG. 4.

FIG. 4 is an explanatory diagram for describing a limited-range search mode according to first embodiment of the present invention.

As shown in FIG. 4, in the limited-range search mode, the scanning range 101 (the first scanning range) is set in a part of the captured image 100 instead of setting the scanning range 101 in the entire captured image 100, and the signpost SP is searched for in the limited range. Thereby, disturbances similar to the signpost SP in portions other than the scanning range 101 (portions indicated by dot patterns in FIG. 4) of the captured image 100 are eliminated, and the search and image processing of the signpost SP in portions other than the scanning range 101 are unnecessary.

The scanning range 101 is set in a range defined by coordinates (x±α, y±β) around the registration position (x, y) of the signpost SP. Also, in the captured image 100, the upper left corner of the captured image 100 is set as coordinates (0, 0), the horizontal direction of the captured image 100 is set as X-coordinates that are positive (+) on the right side, and the vertical direction of the captured image 100 is set as Y coordinates that are positive (+) on the lower side. The absolute values of α and β may be the same or different. When the captured image 100 (i.e., the angle of view of the imaging unit 26) is larger in the left and right directions than in the upward and downward directions as in the present embodiment, the setting may be made so that |α|>|β|.

The scanning range 101 is a range smaller than the entire captured image 100. For example, the scanning range 101 may be a range of ½ or less when the entire captured image 100 is set to 1. Also, the scanning range 101 may preferably be a range of ¼ or less when the entire captured image 100 is set to 1. Also, the scanning range 101 may more preferably be a range of ⅛ or less when the entire captured image 100 is set to 1. Although a lower limit of the scanning range 101 may be a size of the signpost SP immediately before the autonomous mobile robot 1 switches the target to the next signpost SP (a size of the signpost SP on the captured image 100 when the autonomous mobile robot 1 comes closest to the signpost SP that currently guides the autonomous mobile robot 1), the present invention is not limited thereto.

In the limited-range search mode, the first scanning SC1 is performed in a direction from coordinates (x−α, y−β) to coordinates (x+α, y−β), and the line of the first scanning SC1 is gradually shifted downward to search for the signpost SP. When the signpost SP “1, 0, 1” is successfully read by the first scanning SC1 and the second scanning SC2 is subsequently performed vertically from a Y-coordinate (y−β) to a Y-coordinate (y+β) at an intermediate position of an initial X coordinate of “1” where the reading was successful.

When the signpost SP “1, 0, 1” is successfully read by the first scanning SC1 and the signpost SP “1, 0, 1” is successfully read by the second scanning SC2, the signpost SP is detected. The calculation unit 27 acquires a detection position (Sx, Sy) that is the central position of the signpost SP from the outer frame of the detected signpost SP. The detection position (Sx, Sy) of the signpost SP is used for a tracking process to be described below.

In addition to the above-described limited-range search mode, the calculation unit 27 has a full-range search mode for setting the scanning range 101 (the second scanning range) for the entire captured image 100 and searching for the signpost SP. Also, when the signpost SP cannot be detected in the limited-range search mode, the calculation unit 27 switches the mode to the full-range search mode to search for the signpost SP.

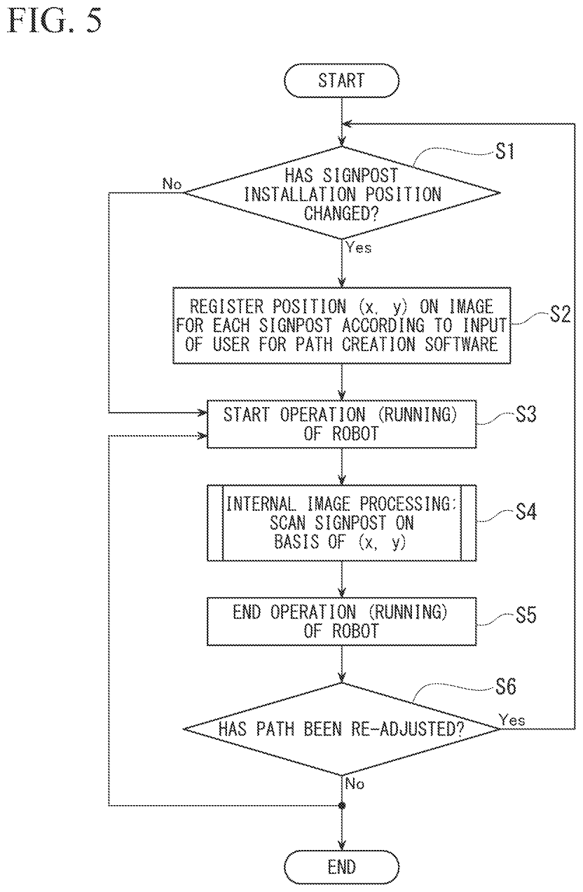

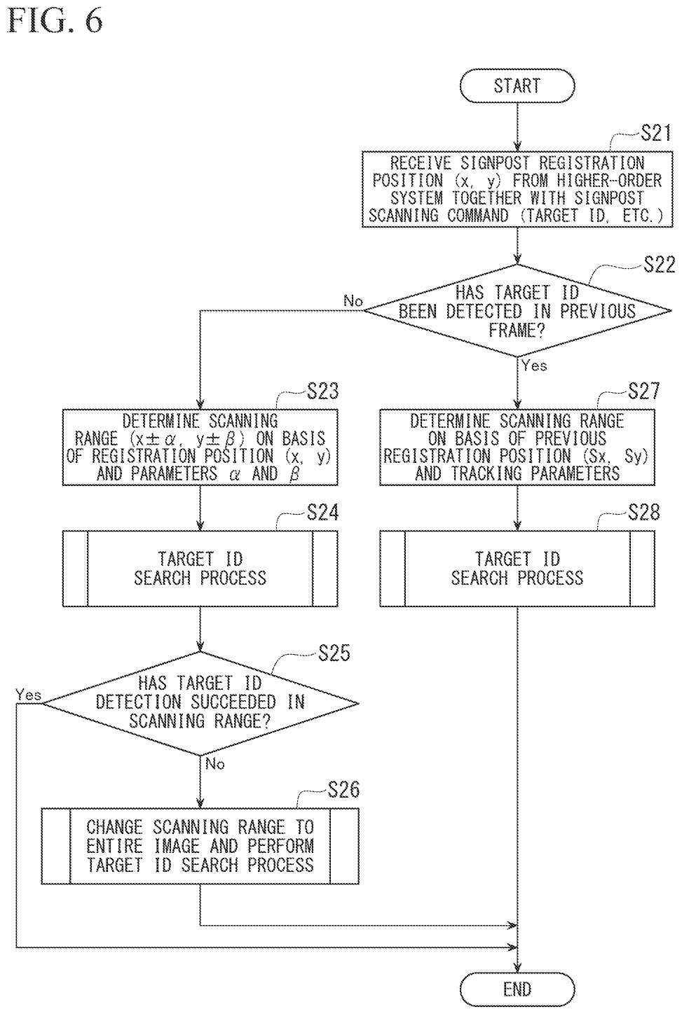

Hereinafter, the operation of the autonomous moving robot 1 and a flow of internal image processing of the autonomous moving robot 1 described above will be specifically described with reference to FIGS. 5 and 6.

FIG. 5 is a flowchart showing path creation and operation of the autonomous moving robot 1 including a user input according to the first embodiment of the present invention. FIG. 6 is a flowchart showing internal image processing of the autonomous moving robot 1 according to the first embodiment of the present invention.

When the autonomous moving robot 1 is operated, a signpost SP is first installed. When the signpost SP is installed or when the signpost SP is already installed and the installation position is changed (in the case of “YES” in step S1 shown in FIG. 5), the registration position (x, y) of the signpost SP on the captured image 100 is input by the user for each signpost SP using the path creation software of the higher-order system (step S2).

In the case of “NO” in step S1 or next to step S2 described above, the operation (running) of the autonomous moving robot 1 is started (step S3). As shown in FIG. 6 to be described below, the autonomous moving robot 1 sets the scanning range 101 on the basis of the registration position (x, y) of the signpost SP, and performs a search for the signpost SP (step S4).

Subsequently, when the operation (running) of the autonomous moving robot 1 ends, as when the autonomous moving robot 1 arrives at the target location or the like, (step S5), it is determined whether or not to re-adjust the movement path 10 of the autonomous moving robot 1 (step S6). When the movement path 10 of the autonomous moving robot 1 is not re-adjusted, the process returns to step S3 and the operation (running) of the autonomous moving robot 1 is resumed (step S3). Also, when the autonomous moving robot 1 stops driving (running), the flow ends.

On the other hand, when the movement path 10 of the autonomous moving robot 1 is re-adjusted, the process returns to step S1, and in step S2, the registration position (x, y) of the signpost SP on the captured image 100 is input by the user for each signpost SP using the path creation software of the higher-order system. Because the subsequent flow is the same, the description thereof is omitted.

Next, internal image processing of the autonomous moving robot 1 in step S4 will be described with reference to FIG. 6. The internal image processing of the autonomous moving robot 1 to be described below is executed for each frame (sheet) of the captured image 100 captured by the imaging unit 26. In the following description, unless otherwise specified, the control unit 23 performs calculations related to the control of running of the autonomous moving robot 1, and the calculation unit 27 performs calculations related to image processing of the autonomous moving robot 1.

First, the calculation unit 27 receives a scanning command (a target ID or the like) of the signpost SP and the registration position (x, y) of the signpost SP from the higher-order system via the communication unit 24 and the control unit 23 (step S21).

Subsequently, the calculation unit 27 determines whether or not the signpost SP including the target ID for which the scanning command has been received has been detected in the previous frame (step S22). When the signpost SP has not been detected in the previous frame (in the case of “No” in step S22), the scanning range (x±α, y±β) is set on the basis of the registration position (x, y) of the signpost SP (step S23). In the limited-range search mode shown in FIG. 4 described above, the signpost SP is searched for (step S24).

In the limited-range search mode, when detection of a signpost SP including a target ID for which the scanning command has been received has failed (in the case of “No” in step S25), the signpost SP is searched for in the full-range search mode in which the scanning range 101 is set in the entire captured image 100 and the signpost SP is searched for in the scanning range 101 (step S26).

In the limited-range search mode or the full-range search mode described above, when the detection of a signpost SP including the target ID for which the scanning command has been received has succeeded (in the case of “Yes” in step S25 or next to step S26), step S22 becomes “Yes” in the next frame, and the process proceeds to a tracking process (a tracking mode) of steps S27 and S28.

In this tracking process, the scanning range 101 is set on the basis of the detection position (Sx, Sy) and tracking parameters (parameters corresponding to the above-described α and β of the signpost SP detected in the previous frame (step S27). A search process for searching for the signpost SP in the scanning range 101 is executed (step S28). Also, in the tracking process, a tracking parameter set in a scanning range 101 (a third scanning range) smaller than the scanning range 101 of the limited-range search mode described above may be set. Also, the tracking parameter is variable as a case where the tracking parameter is set from a length of a start bar (“1, 0, 1”) of the previously detected signpost SP or the like instead of one value. Thereby, it becomes a scanning range in which the signpost SP shown in a large size due to approaching can also be detected.

The tracking process is iterated until the distance Z from the autonomous moving robot 1 to the target signpost SP approaches a prescribed threshold value and the target is switched to the next signpost SP. When it is time to switch the target to the next signpost SP, in step S21, a scanning command (the target ID or the like) and a registration position (x, y) of the next signpost SP are transmitted from the higher-order system. And, the autonomous moving robot 1 re-searches for the signpost SP including the target ID for which the scanning command has been received in the limited-range search mode or the full-range search mode. Because the subsequent flow is the same, the description thereof is omitted.

Thus, according to the above-described first embodiment, the autonomous moving robot 1 for reading signposts SP disposed along the movement path 10 using the imaging unit 26 mounted therein and moving in accordance with guidance of the signposts SP includes the calculation unit 27 having a limited-range search mode in which the scanning range 101 (the first scanning range) is set in a part of a captured image 100 captured by the imaging unit 26 on the basis of a registration position of the signpost SP and the signpost SP is searched for in the scanning range 101. According to this configuration, as shown in FIG. 4, disturbances similar to the signpost SP in a portion of the captured image 100 (a portion indicated by a dot pattern) other than the scanning range 101 are eliminated and the search and image processing of the signpost SP in the portion other than the scanning range 101 are unnecessary. Therefore, the accuracy of detection of the signpost SP can be improved in the autonomous moving robot 1 and a period of image processing time can be reduced.

Also, according to the first embodiment, when the signpost SP cannot be detected in the limited-range search mode, the calculation unit 27 searches for the signpost SP by switching a mode to a full-range search mode, the full-range search mode in which a scanning range 101 (a second scanning range) is set in the entire captured image 100 and the signpost SP is searched for in the scanning range 101. According to this configuration, even if the signpost SP cannot be detected in the limited-range search mode due to a mismatch in the registration position of the signpost SP, the signpost SP can be detected in the full-range search mode.

Also, according to the first embodiment, the registration position of the signpost SP is set in correspondence with each signpost SP of the plurality of signposts SP, and the calculation unit 27 searches for the signpost SP based on the limited-range search mode by switching the registration position of the signpost SP to a registration position corresponding to the each signpost SP every time the signpost SP for guiding the autonomous moving robot 1 is switched. According to this configuration, as shown in FIG. 1, for example, even if there is a variation in the installation position of the signpost SP for the movement path 10, the optimal scanning range 101 is individually set in the limited-range search mode, and the target signpost SP can be accurately detected in a short time.

### Second Embodiment

Next, a second embodiment of the present invention will be described. In the following description, components identical or equivalent to those of the above-described embodiment are denoted by the same reference signs and the description thereof is simplified or omitted.

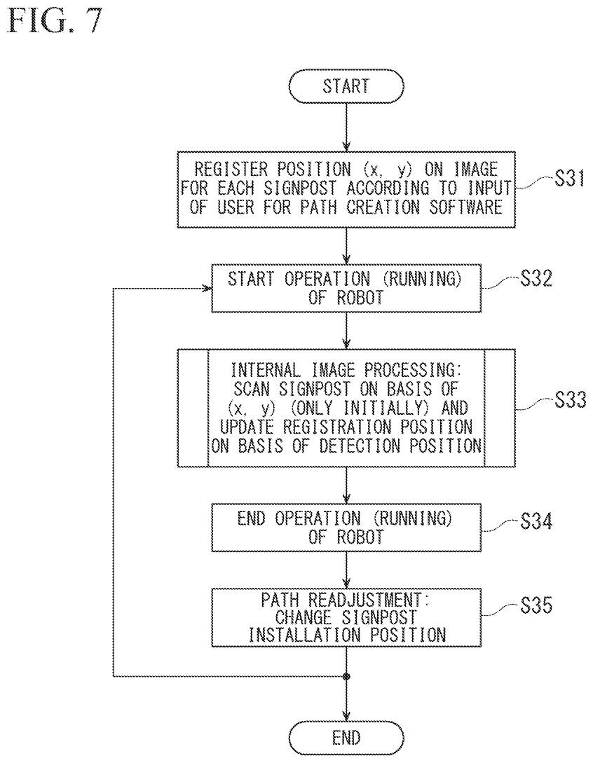

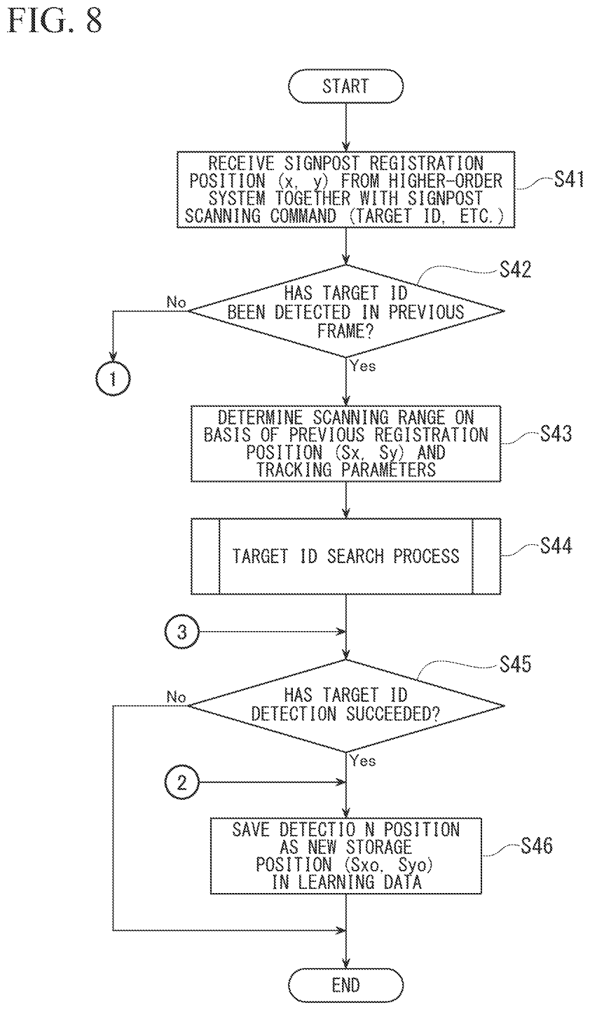

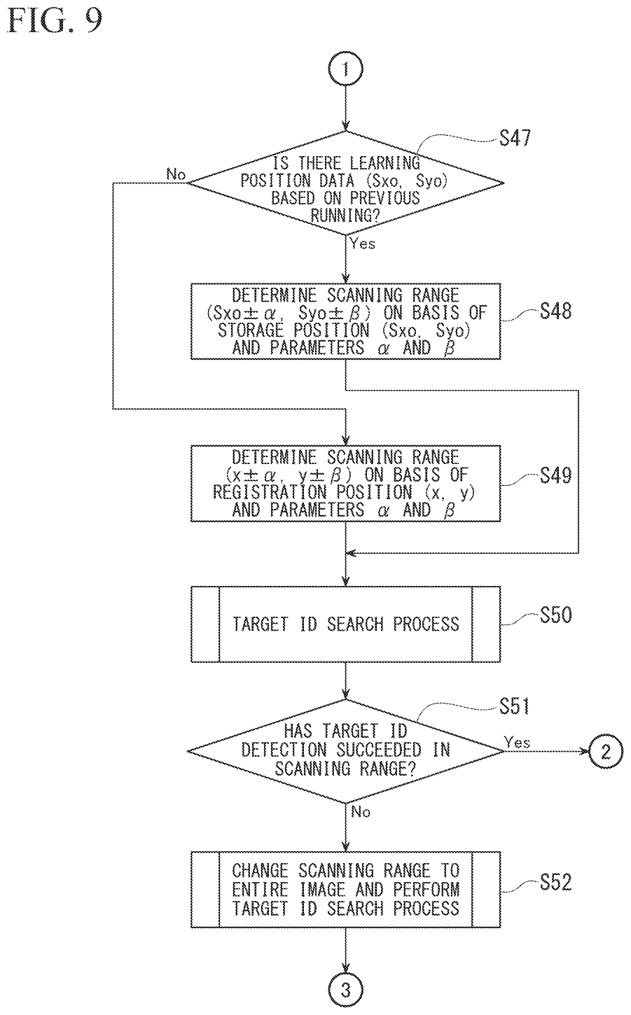

FIG. 7 is a flowchart showing path creation and operation of the autonomous moving robot 1 including a user input according to the second embodiment of the present invention. FIGS. 8 and 9 are flowcharts showing internal image processing of the autonomous moving robot 1 according to the second embodiment of the present invention. Also, circled numbers 1 to 3 shown in FIGS. 8 and 9 indicate the connections of the two flows shown in FIGS. 8 and 9.

As shown in these drawings, the autonomous moving robot 1 of the second embodiment has a learning function, updates a detection position of the previously detected signpost SP as the registration position of the signpost SP to be subsequently searched for, and optimizes the search and image processing of the signpost SP.

In the second embodiment, first, as shown in FIG. 7, the registration position (x, y) of the signpost SP on the captured image 100 is input by the user for each signpost SP using the path creation software of the higher-order system (step S31). Here, the registration position (x, y) of the signpost SP input by the user is an initial value and is updated by learning to be described below.

Subsequently, the operation (running) of the autonomous moving robot 1 is started (step S32). The autonomous moving robot 1 sets the scanning range 101 on the basis of the registration positions (x, y) of the signpost SP, and searches for the signpost SP (step S33). This process is performed only initially, and subsequently, the registration position (x, y) is automatically updated on the basis of the detection position (Sx, Sy) of the signpost SP, and the signpost SP is searched for.

When the autonomous moving robot 1 arrives at a target location, the operation (running) of the autonomous moving robot 1 ends, as when the autonomous moving robot 1 arrives at a target location or the like, (step S34). Subsequently, when the movement path 10 is re-adjusted by a slight change in the installation position of the signpost SP or the like (step S35), the process does not return to the user input of step S31 in the second embodiment unlike the first embodiment described above. Instead, by returning to step S32 and resuming the operation (running) of the autonomous moving robot 1, the registration position (x, y) of the signpost SP is automatically updated (step S33).

Next, internal image processing of the autonomous moving robot 1 in step S33 will be described with reference to FIGS. 8 and 9. The internal image processing of the autonomous moving robot 1 to be described below is executed for each frame (sheet) of the captured image 100 captured by the imaging unit 26. In the following description, unless otherwise specified, the control unit 23 performs calculations related to the control of running of the autonomous moving robot 1, and the calculation unit 27 performs calculations related to image processing of the autonomous moving robot 1.

As shown in FIG. 8, first, the calculation unit 27 receives a scanning command (a target ID or the like) of the signpost SP and a registration position (x, y) of the signpost SP from the higher-order system via the communication unit 24 and the control unit 23 (step S41).

Subsequently, the calculation unit 27 determines whether or not the signpost SP including the target ID for which the scanning command has been received has been detected in a previous frame (step S42). When the signpost SP has not been detected in the previous frame (in the case of “No” in step S42), it is determined whether or not there is learning position data (Sx₀, Sy₀) due to past running as shown in FIG. 9 (step S47).

When the learning position data (Sx₀, Sy₀) due to past running is not present (in the case of “No” in step S47), as in the first embodiment described above, the scanning range (x±α, y±β) is set on the basis of the registration position (x, y) of the signpost SP (step S49), and the signpost SP is searched for in the limited-range search mode (step S50).

On the other hand, if there is learning position data (Sx₀, Sy₀) due to past running (in the case of “Yes” in step S47), the scanning range (Sx₀±α, Sy₀±β) is set on the basis of the stored learning position data (Sx₀, Sy₀) (step S48), and the signpost SP is searched for in the limited-range search mode (step S50).

In any limited-range search mode described above, when the detection of a signpost SP including a target ID for which a scanning command has been received has succeeded (in the case of “Yes” in step S51), the process proceeds to step S46 of FIG. 8, the detection position (Sx, Sy) of the signpost SP is saved as the learning position data (Sx₀, Sy₀), and the registration position (x, y) of the signpost SP for use in the next search is updated.

On the other hand, when detection of a signpost SP including a target ID for which a scanning command has been received has failed in the limited-range search mode (in the case of “No” in step S51 shown in FIG. 9), the scanning range 101 is set for the entire captured image 100, and the signpost SP is searched for in the full-range search mode (step S52).

When the signpost SP has been searched for in the full-range search mode, the process proceeds to step S45 of FIG. 8, it is determined whether or not the detection of the signpost SP including the target ID for which the scanning command has been received has succeeded. When the detection of the signpost SP containing the target ID for which the scanning command has been received has succeeded (in the case of “Yes” in step S45 shown in FIG. 8), the detection position (Sx, Sy) of the signpost SP is saved as learning position data (Sx₀, Sy₀), and the registration position (x, y) of the signpost SP for use in the next search is updated (step S46).

On the other hand, when the detection of the signpost SP containing the target ID for which the scanning command has been received has failed in the full-range search mode (in the case of “No” in step S45 shown in FIG. 9), the detection position (Sx, Sy) of the signpost SP is not saved as learning position data (Sx₀, Sy₀), and the process ends. Because the subsequent flow is the same, the description thereof is omitted.

Thus, according to the second embodiment described above, when the signpost SP has been detected, the calculation unit 27 updates the detection position (Sx, Sy) of the signpost SP as the registration position (x, y) of the signpost SP to be subsequently searched for. According to this configuration, the user does not need to input the registration position (x, y) of the signpost SP every time the installation position of the signpost SP is adjusted, and the search and image processing of the signpost SP can be automatically optimized.

Also, in the above-described second embodiment, when the signpost SP is searched for on the basis of an updated registration position (learning position data (Sx₀, Sy₀)) of the signpost SP in the limited-range search mode, the calculation unit 27 may set a scanning range 101 that is smaller than a scanning range 101 based on a previous limited-range search mode. By optimizing the scanning range 101 of the signpost SP according to the learning function as compared with a previous process, the probability of detecting the signpost SP is improved even if the scanning range 101 is reduced (for example, α and β are reduced by 10%). Therefore, the scanning range 101 of the limited-range search mode can be made smaller than that of the previous search, thereby reducing a period of image processing time. Also, when the detection of the signpost SP fails as a result of reducing the scanning range 101, the scanning range 101 may be returned to a size at the time of the previous search (for example, a and (3 may be returned to the original values).

### Third Embodiment

Next, a third embodiment of the present invention will be described. In the following description, components identical or equivalent to those of the above-described embodiment are denoted by the same reference signs and the description thereof is simplified or omitted.

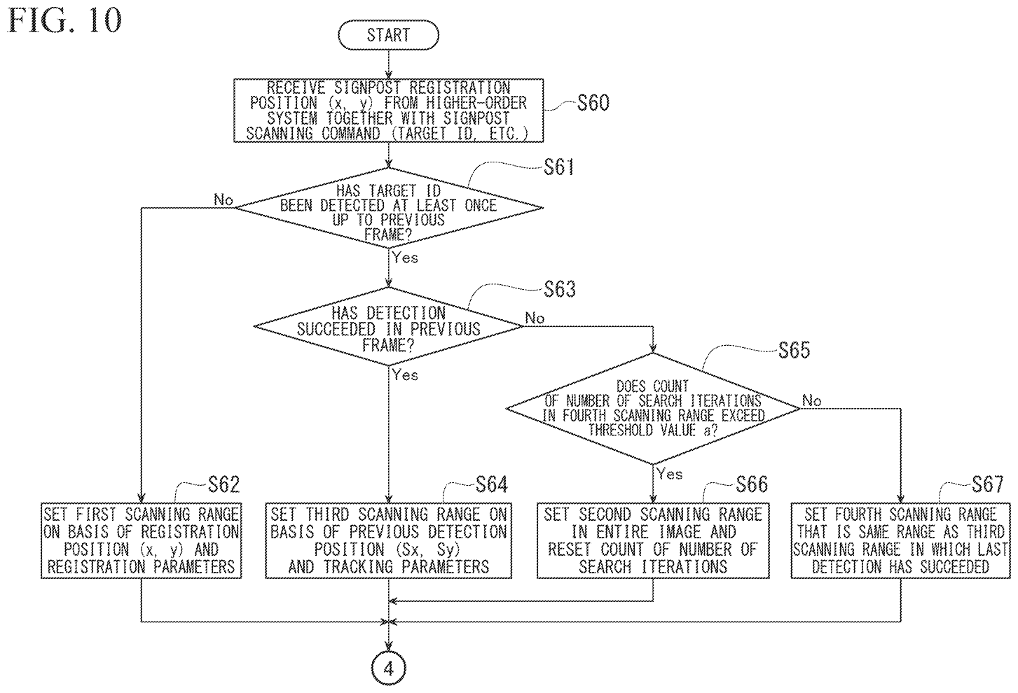

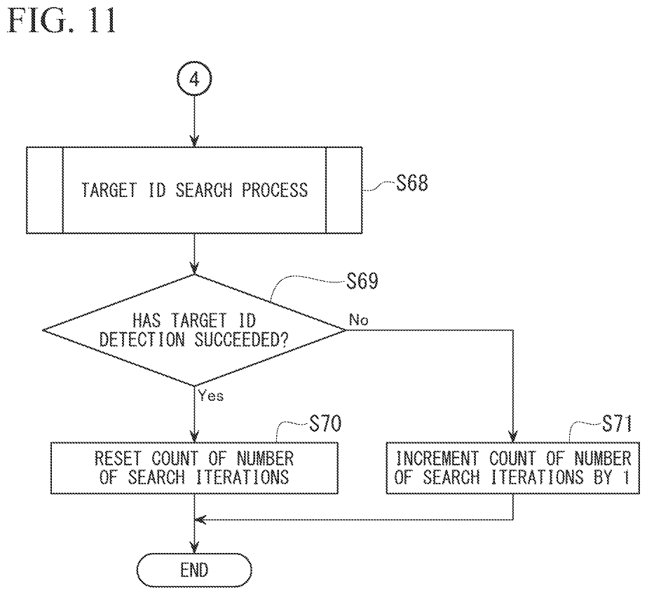

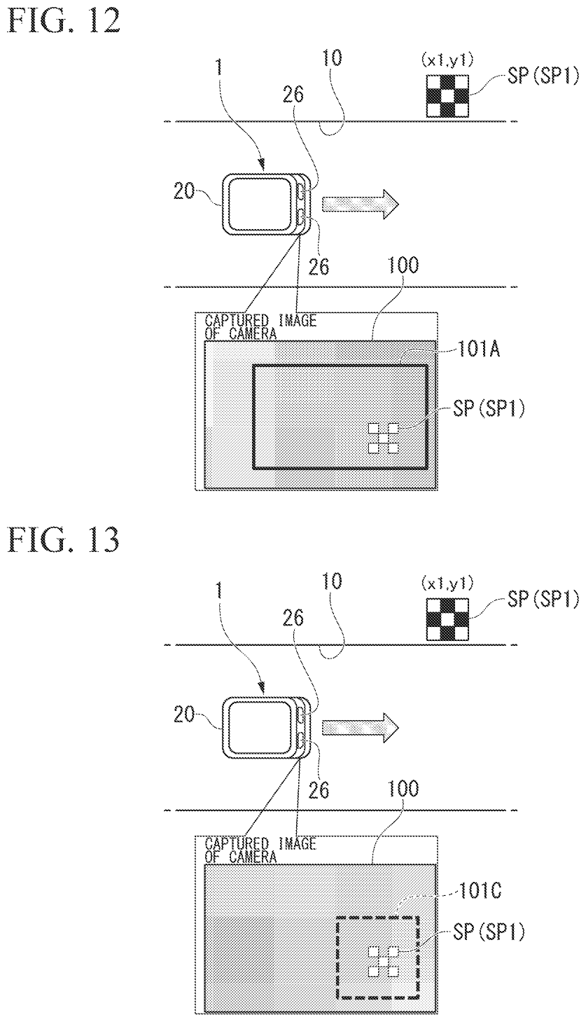

FIGS. 10 and 11 are flowcharts showing internal image processing of an autonomous moving robot 1 according to the third embodiment of the present invention. Also, a circled number 4 shown in FIGS. 10 and 11 indicates the connection of the two flows shown in FIGS. 10 and 11. FIGS. 12 to 16 are schematic diagrams showing a movement state of the autonomous moving robot 1 according to the third embodiment of the present invention viewed from above.

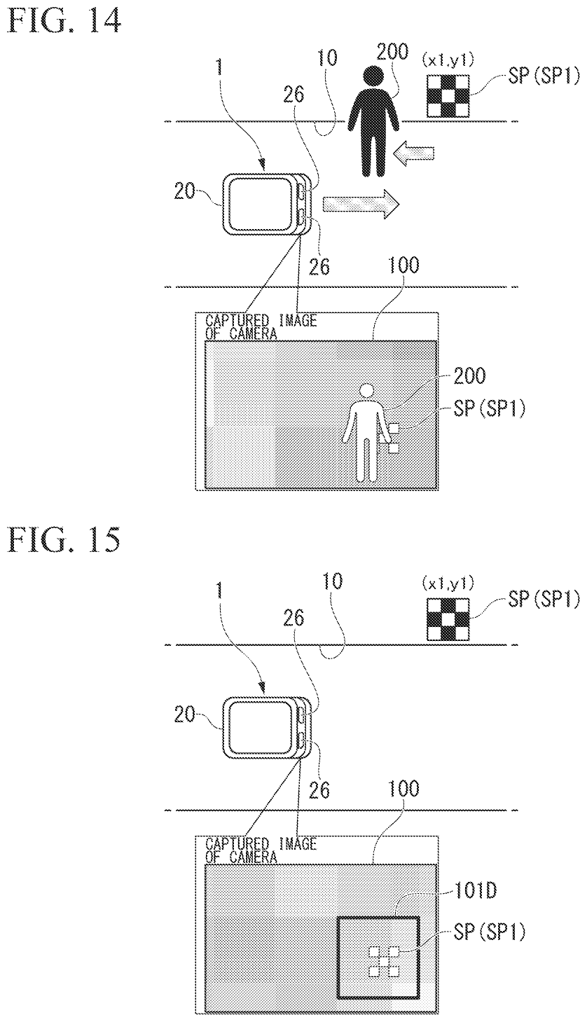

The autonomous mobile robot 1 of the third embodiment is programmed to continue a tracking mode without interrupting the process even if a signpost SP is blocked by a passerby 200 or the like, for example, as shown in FIG. 14, during the above-described tracking process of steps S27 and S28 (referred to as the tracking mode).

Internal image processing of the autonomous moving robot 1 to be described below is executed for each frame (sheet) of the captured image 100 captured by the imaging unit 26. Also, in the following description, unless otherwise specified, the control unit 23 performs calculations related to the control of running of the autonomous moving robot 1, and the calculation unit 27 performs calculations related to image processing of the autonomous moving robot 1.

As shown in FIG. 10, first, the calculation unit 27 receives a scanning command (a target ID or the like) of the signpost SP and the registration position (x, y) of the signpost SP from the higher-order system via the communication unit 24 and the control unit 23 (step S60).

Subsequently, the calculation unit 27 determines whether or not the signpost SP including the target ID for which a scanning command has been received has been detected at least once up to a previous frame (step S61). That is, the calculation unit 27 determines whether or not the signpost SP including the target ID for which the scanning command has been received has been detected in the limited-range search mode or the full-range search mode described above.

When the signpost SP has not been detected even once up to the previous frame (in the case of “No” in step S61), the first scanning range 101A is set as shown in FIG. 12 on the basis of the registration position (x, y) of the signpost SP (step S62). The first scanning range 101A is a scanning range of the limited-range search mode described above. That is, the calculation unit 27 first searches for the signpost SP in the limited-range search mode, and if the search has failed, the calculation unit 27 switches the mode to the full-range search mode to search for the signpost SP.

On the other hand, when the signpost SP has been detected at least once up to the previous frame (in the case of “Yes” in step S61), it is determined whether or not the signpost SP has been successfully detected in the previous frame (step S63). When the signpost SP has been successfully detected in the previous frame (in the case of “Yes” in step S63), the third scanning range 101C is set as shown in FIG. 13 on the basis of the previous detection position (Sx, Sy) of the signpost SP and the tracking parameters (a size of the previously detected signpost SP and the like) (step S64).

The third scanning range 101C is the scanning range of the tracking mode described above. That is, when the signpost SP can be detected in the limited-range search mode or the full-range search mode, the calculation unit 27 sets a third scanning range 101C for tracking the signpost SP, and switches the mode to the tracking mode in which the signpost SP is searched for in the third scanning range 101C to search for the signpost SP. Also, the flow up to this point is similar to that of the above-described embodiment.

On the other hand, when the detection of the signpost SP has failed in the previous frame (in the case of “No” in step S63), i.e., when the signpost SP is blocked by the passerby 200 or the like, and the signpost SP becomes undetectable during the tracking mode as shown in FIG. 14, the process proceeds to step S65. In step S65, the calculation unit 27 determines whether or not the count of the number of search iterations in the fourth scanning range 101D to be described below exceeds a threshold value a.

When the count of the number of search iterations in the fourth scanning range 101D does not exceed the threshold value a (in the case of “No” in step S63), the process proceeds to step S67, and the fourth scanning range 101D is set as shown in FIG. 15. That is, when the signpost SP has not been detected in the tracking mode, the calculation unit 27 sets the fourth scanning range 101D, that is the same range as the last third scanning range 101C in which the signpost SP has been detected, without terminating the program, and switches the mode to the re-search mode in which the signpost SP is re-searched for in the fourth scanning range 101D to search for the signpost P.

In the re-search mode (i.e., when the signpost SP has not been detected in the tracking mode), as shown in FIG. 15, the movement of the autonomous moving robot 1 is stopped. Thereby, the autonomous moving robot 1 can safely re-search for the signpost SP.

As shown in FIG. 11, as a result of the target ID search process (step S68) in the fourth scanning range 101D, if the detection of the signpost SP including the target ID for which the scanning command has been received has succeeded (in the case of “Yes” in step S69), the count of the number of search iterations is reset (step S70). When the count of the number of search iterations is reset, in the next frame, the above-described step S63 shown in FIG. 10 becomes “Yes” (the previous frame has been successfully detected), and the mode returns to the tracking mode (step S64), such that the movement of the autonomous moving robot 1 and the tracking of the signpost SP are resumed.

On the other hand, as shown in FIG. 11, when the detection of the signpost SP in the fourth scanning range 101D has failed (in the case of “No” in step S69), the number of search iterations is counted up (+1) (step S71). The number of search iterations increased in the count process is used in step S65 described above in the next frame. When the count of the number of search iterations in step S65 does not exceed the threshold value a (in the case of “No” in step S63), for example, the passerby 200 shown in FIG. 14 has not yet passed in front of the signpost SP.

The threshold value a is set, for example, to the number of frames that is 10. The threshold value a may be adjusted to the number of frames greater than or equal to that of an average time for the passerby 200 of a normal walking speed to pass through the signpost SP. When the detection of the signpost SP has succeeded within a range not exceeding the threshold value a, the count of the number of search iterations is reset (step S70), and the mode returns to the above-described tracking mode (step S64), such that the movement of the autonomous moving robot 1 and the tracking of the signpost SP are resumed.

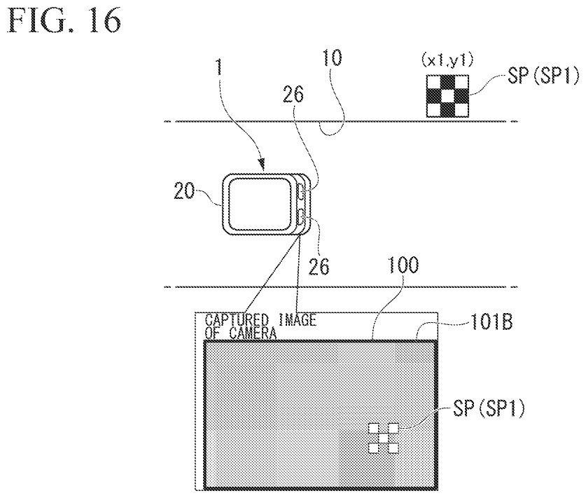

On the other hand, when the count of the number of search iterations exceeds the threshold value a (in the case of “Yes” in step S63), the process proceeds to step S66, the second scanning range 101B is set as shown in FIG. 16, and the count of the number of search iterations is reset. The second scanning range 101B is a scanning range of the full-range search mode described above. That is, the calculation unit 27 re-searches for the signpost SP in the re-search mode, and if the re-search has failed, the calculation unit 27 switches the mode to the full-range search mode to re-search for the signpost SP.

When the detection of the signpost SP has succeeded in the second scanning range 101B, in the next frame, the above-described step S63 becomes “Yes” (the previous frame has been successfully detected), and the mode returns to the tracking mode (step S64), such that the movement of the autonomous moving robot 1 and the tracking of the signpost SP are resumed.

Thus, according to the above-described third embodiment, when the signpost SP (the signpost SP at the beginning of viewing) has been detected in the limited-range search mode or the full-range search mode, the calculation unit 27 sets the third scanning range 101C for tracking the signpost SP, and switches the mode to the tracking mode in which the signpost SP is searched for in the third scanning range 101C to search for the signpost SP.

The limited-range search mode of the first and second embodiments (the full-range search mode if detection fails) has been applied only at the beginning of viewing the signpost SP. The reason is that after the signpost SP is detected from the beginning of viewing the signpost SP and the autonomous moving robot 1 runs, the position of the signpost SP in the captured image 100 changes, and the size of the signpost SP increases as the autonomous moving robot 1 approaches the signpost SR That is, the first scanning range 101A of the limited-range search mode based on the registration position registered in advance cannot be used continuously. Therefore, if the search is performed in the first scanning range 101A according to the registration position at the beginning of viewing and the signpost SP is successfully detected, the mode is subsequently switched to the tracking mode, and the signpost SP is tracked, such that a process of detecting the signpost SP in the limited range is possible throughout until the running of the autonomous moving robot 1 ends.

Also, in the above-described third embodiment, when the signpost SP has not been detected in the tracking mode, the calculation unit 27 searches for the signpost SP by switching the mode to a re-search mode. In the re-search mode, the fourth scanning range 101D that is the same range as the last third scanning range 101C in which the signpost SP could be detected is set, and the signpost SP is re-searched for a plurality of times in the fourth scanning range 101D. According to this configuration, in the event of exceptions during actual operation, for example, when the signpost SP is blocked by the passerby 200 or the like and the signpost SP becomes undetectable, it is possible to continue the tracking mode by iterating the re-search until the signpost SP becomes visible again due to the passerby 200 moving or any other reason. That is, by performing the re-search in the fourth scanning range 101D that is the same range as the third scanning range 101C immediately before the signpost SP is blocked and detection fails, it is possible to implement the search in the limited range not only at the beginning of viewing the signpost SP but also from beginning to end.

Also, in the above-described third embodiment, in the re-search mode, the movement is stopped. According to this configuration, even if the autonomous mobile robot 1 loses sight of the signpost SP, the autonomous mobile robot 1 can safely perform a re-search for the signpost SP.

Also, in the above-described third embodiment, when the signpost SP cannot be detected in the re-search mode, the calculation unit 27 switches the mode to the full-range search mode and searches for the signpost SP. According to this configuration, when the signpost SP is visible again, even if the signpost SP cannot be detected in the re-search mode, the signpost SP can be detected in the full-range search mode and the tracking mode can be resumed.

While preferred embodiments of the present invention have been described above with reference to the drawings, the present invention is not limited to the above-described embodiments. Various shapes and combinations of constituent members shown in the above-described embodiments are merely examples, and can be variously changed on the basis of design requests and the like without departing from the scope of the present invention.

Although a configuration in which the autonomous moving robot 1 is a vehicle has been described in the above-described embodiment as an example, the autonomous moving robot 1 may be a flying body commonly known as a drone.

Although a configuration in which a plurality of signposts SP are disposed along the movement path 10 has been described in the above-described embodiment as an example, a configuration in which only one signpost SP is disposed may be used.

### INDUSTRIAL APPLICABILITY

According to the above-described autonomous moving robot, it is possible to improve the accuracy of sign detection and reduce a period of image processing time.

### REFERENCE SIGNS LIST

1 Autonomous moving robot
10 Movement path
20 Robot body
20L Drive wheel
20R Drive wheel
21 Signpost detection unit
22 Drive unit
23 Control unit
24 Communication unit
25 Irradiation unit
26 Imaging unit
27 Calculation unit
28 Motor control unit
29 Motor
100 Captured image
101 Scanning range
C Detection target
SP Signpost (sign)

What is claimed is:

1. An autonomous moving robot for reading a sign disposed along a movement path using an imaging unit mounted therein, and being guided and moving in accordance with the sign, the autonomous moving robot comprising:
a calculation unit having a limited-range search mode, the limited-range search mode in which a first scanning range is set in a part of a captured image captured by the imaging unit on the basis of a registration position of the sign and the sign is searched for in the first scanning range.

2. The autonomous moving robot according to claim 1, wherein
when the sign cannot be detected in the limited-range search mode, the calculation unit searches for the sign by switching the mode to a full-range search mode, the full-range search mode in which a second scanning range is set in the entire captured image and the sign is searched for in the second scanning range.

3. The autonomous moving robot according to claim 2, wherein
when the sign has been detected in the limited-range search mode or the full-range search mode, the calculation unit searches for the sign by switching the mode to a tracking mode, the tracking mode in which a third scanning range for tracking the sign is set and the sign is searched for in the third scanning range.

4. The autonomous moving robot according to claim 3, wherein
when the sign has not been detected in the tracking mode, the calculation unit searches for the sign by switching the mode to a re-search mode, the re-search mode in which a fourth scanning range that is the same range as the last third scanning range in which the sign could be detected is set and the sign is re-searched for a plurality of times in the fourth scanning range.

5. The autonomous moving robot according to claim 4, wherein
movement is stopped in the re-search mode.

6. The autonomous moving robot according to claim 4, wherein
when the sign cannot be detected in the re-search mode, the calculation unit searches for the sign by switching the mode to the full-range search mode.

7. The autonomous moving robot according to claim 1, wherein
a plurality of the signs are disposed along the movement path,
the registration position of the sign is set in correspondence with each sign of the plurality of the signs, and
the calculation unit searches for the sign based on the limited-range search mode by switching the registration position of the sign to a registration position corresponding to the each sign every time the sign for guiding the autonomous moving robot is switched.

8. The autonomous moving robot according to claim 1, wherein when the sign has been detected, the calculation unit updates a detection position of the sign as the registration position of the sign to be subsequently searched for.

9. The autonomous moving robot according to claim 8, wherein
when the sign is searched for on the basis of an updated registration position of the sign in the limited-range search mode, the calculation unit sets the first scanning range that is smaller than a first scanning range based on a previous limited-range search mode.
